(19) United States
(12) Patent Application Publication
(10) Pub. No.: US 2004/0047793 A1
(43) Pub. Date: Mar. 11, 2004

(54) Method for producing trichlorosilane

(76) Inventors: Leslaw Mleczko, Bochum (DE); Sigurd Bucholz, Koln (DE); Torsten Sill, Schwelm (DE); Frank Becker, Hanau (DE)

Correspondence Address: MCGLEW & TUTTLE, PC, 1 SCARBOROUGH STATION PLAZA, SCARBOROUGH, NY, 10510-0827, US

(21) Appl. No.: 10/450,457

(22) PCT Filed: Nov. 21, 2001
(86) PCT No.: PCT/EP01/13496

(30) Foreign Application Priority Data
Dec. 14, 2000 (DE) 100624138

(51) Int. Cl. C01B 33/107

(52) U.S. Cl. 423/342

(57) ABSTRACT

The invention relates to a method for producing trichlorosilane by reacting silicon with silicon tetrachloride and hydrogen while adding hydrogen chloride, the residence time of the hydrogen chloride in the reaction chamber being less than the residence time of the silicon tetrachloride.

The present invention relates to a method for producing trichlorosilane.

Trichlorosilane HSiCl₃ is a valuable intermediate product for producing high-purity silicon, dichlorosilane H₂SiCl₂, silane SiH₄ and bonding agents. The methods used for producing trichlorosilane differ in technical terms.

From EP 658 359 A2 and DE 196 54 154 A1 it is known to hydrate silicon tetrachloride with hydrogen either at a high temperature or in the presence of catalysts.

In U.S. Pat. No. 4,676,967 it is mentioned to manufacture trichlorosilane by reacting silicon with hydrogen chloride in a fluidized bed at a temperature of approx. 300° C. From this a mixture is obtained that contains apart from trichlorosilane also high quantities of silicon tetrachloride and furthermore dichlorosilane, metal halides and polysilanes. The execution of the method requires comparatively big reactors. In addition to this, the disposal of the by-products, particularly of the polysilanes, is expensive.

Reacting silicon with silicon tetrachloride and hydrogen to form trichlorosilane in a temperature range from 400° C. to 600° C. is known from U.S. Pat. No. 4,676,967 and CA-A-1,162,028. This method gained particular importance in those cases, where the further processing of trichlorosilane results inevitably in the production of silicon tetrachloride, because in that case the inevitably produced silicon tetrachloride can be re-transformed directly and advantageously into trichlorosilane. This is the case, for example, in the manufacture of dichlorosilane and of silane by disproportionation of trichlorosilane.

This method can be integrated as a partial step in various more comprehensive continuous processes, e.g. in processes for producing silane or hyper-pure silicon.

For example in U.S. Pat. No. 4,676,967 and CA-A-1,162,028 methods for producing hyper-pure silane and high-purity silicon are disclosed, wherein in a first step metallurgical silicon is reacted with hydrogen and silicon tetrachloride to trichlorosilane. The reaction is carried out at temperatures from approx. 400 to 600° C. and under increased pressure above 100 psi (6.89 bar). The reaction under increased pressure is necessary in order to increase the yield of trichlorosilane. In a subsequent step trichlorosilane is disproportionated to silane. This results inevitably in the production of silicon tetrachloride which is recycled and introduced again to be reacted with hydrogen and metallurgical silicon. Finally the produced silane can be thermally decomposed to hyper-pure silicon and hydrogen.

Many attempts have been made to make the manufacture of trichlorosilane from silicon, silicon tetrachloride and hydrogen more efficient. So it was suggested already in U.S. Pat. No. 4,676,967 and CA-A-1,162,028 to add a catalyst system.

Due to lower costs and higher activity compared to pure silicon mostly a silicon of metallurgical quality is used as raw material in the method specified above which contains contaminations in form of different other metallic elements (even as much as certain percentages). Such contaminations are treated while cleaning the chlorosilane products and are mostly chemically or physically separated in form of chlorides. The resulting loss of chlorine needs to be replaced therefore. The use of hydrogen chloride is a potential way to replace the loss. Hydrogen chloride reacts in an exothermic reaction with silicon forming the products trichlorosilane, silicon tetrachloride and hydrogen.

From DE 33 03 903 A1 a method for the manufacture of trichlorosilane from silicon, particularly from contact masses containing residual silicon is known, wherein silicon is brought in contact with a anhydrous chloride source such as hydrogen chloride gas and/or chloric gas in the presence of silicon tetrachloride at an increased temperature. Adding hydrogen is not specified. Preferably hydrogen chloride gas and/or chloric gas of a quantity from 10 to 99 mol-%, particularly preferred from approx. 28 to 44 mol-%, is added.

It is also known (Ingle and Peffley, J. Electrochem. Soc., 1985, 1236-1240) to react silicon of various qualities with silicon tetrachloride, hydrogen and hydrogen chloride, either in the presence or in the absence of catalyst. The hydrogen chloride is added clearly excessively, however, compared to the silicon tetrachloride, so that silicon tetrachloride that is inevitably produced in a subsequent reaction of trichlorosilane, e.g. to form silane or high-purity silicon, cannot be re-transformed beneficially to trichlorosilane. The reason is that the amount of chlorine provided in the system in such processes, i.e. fixed chlorine, e.g. in form of silicon tetrachloride, trichlorosilane, dichlorosilane and hydrogen chloride, does not decrease. The high amount of chlorine added due to the addition of hydrogen chloride results in a stoichiometric increase of silicon tetrachloride provided in the system. The chlorine balance can be compensated only by the undesired discharge of species containing chlorine, e.g. silicon tetrachloride.

From U.S. Pat. No. 4,526,769 the manufacture of trichlorosilane from silicon, silicon tetrachloride, hydrogen and hydrogen chloride in a two-stage process is known. In a first stage, the reaction is carried out at high temperatures of 550-700° C. according to the equation:

3SiCl₄+2H₂+Si [symbol] SiHCl₃

In a second stage hydrogen chloride is added to the mixture produced in the first stage and the reaction is carried out at temperatures from 230 to 400° C. resulting in the following transformation:

HCl+Si→HSiCl₃+SiCl₄+H₂

The selectivity to the products silicon tetrachloride and trichlorosilane in this reaction depends strongly on the reaction temperature during the two stages. With an increasing reaction temperature predominantly SiCl₄ is formed. Such two-stage process can be carried out in a reactor, wherein the first stage is carried out at T=500°-700° C., preferably at T=550°-650° C., and the second stage at 300-350° C., preferably at 325±15° C. The temperature must therefore be kept constant in a comparatively small tolerance range, particularly in the second stage. In both stages educt silicon is introduced, the different temperatures achieved by means of a heat exchanger system serve to obtain a suitable product distribution. Disadvantages of the method specified above are the expensive construction of the two stages and the complicated efforts required for controlling and executing the reaction, particularly for maintaining the necessary temperatures.

So no continuously executable, simple one-stage method for the manufacture of trichlorosilane from silicon, silicon tetrachloride, hydrogen and hydrogen chloride is known, wherein high yields can be achieved and wherein apart from this the addition of hydrogen chloride does not result in an increased formation of silicon tetrachloride (SiCl₄) instead of trichlorosilane (SiHCl₃). The object of the present invention was therefore to provide such an advantageous method.

Subject-matter of the invention is a method for producing trichlorosilane by reacting silicon with silicon tetrachloride and hydrogen while adding hydrogen chloride, characterised in that the residence time of the hydrogen chloride in the reaction chamber is 10⁻³ to 50% of the residence time of the silicon tetrachloride.

The residence time of a component in this context is the quotient of reactor volume and the volume stream of the respective component (hydrogen chloride and/or silicon tetrachloride).

Until now only the undesired reduction of the potential trichlorosilane yield due to the introduction of hydrogen chloride together with the other educts silicon tetrachloride and hydrogen was described. Surprisingly this is not observed when adding hydrogen chloride in the method according to the invention.

On the contrary, the addition of hydrogen chloride to the reaction mixture of silicon, silicon tetrachloride and hydrogen in the method according to the invention wherein the residence time of hydrogen chloride in the reaction chamber is 10⁻³ to 50% of the residence time of silicon tetrachloride, results in an unexpected clear increase of the percentage of trichlorosilane contained in the product gas, which leads finally to the result that in a one-stage process and even without adding catalyst high yields of trichlorosilane, i.e. high reaction rates of the silicon tetrachloride introduced and the hydrogen chloride, and at the same time high total yields can be obtained, which means a high utilisation of the silicon employed, reducing the amount of silicon tetrachloride to be circulated. Only with longer residence times of hydrogen chloride and/or higher temperatures silicon tetrachloride is formed. For this reason it is possible to achieve a clearly higher yield of trichlorosilane by the short residence time of the gas containing hydrogen chloride to be observed according to the invention.

The reaction chamber in this context is the zone of the reactor where silicon is provided which is reacted with the educts silicon tetrachloride and hydrogen.

Preferably the residence time of the hydrogen chloride in the reaction chamber is 10⁻³ to 20% of the residence time of silicon tetrachloride, particularly preferred 10⁻³ to 5%.

Hydrogen chloride is preferably employed in an anhydrous form as hydrogen chloride gas, but it is also possible to use a mixture of hydrogen chloride gas and an inert gas, e.g. argon.

For example, 0.05-20 weight percent, preferably 0.1-10 weight percent hydrogen chloride based on the amount of silicon tetrachloride added is employed.

The residence time of hydrogen chloride according to the invention in the reaction chamber can be adjusted, for example, in that silicon tetrachloride and hydrogen are introduced from below in the reaction chamber by means of a gas distributor, while hydrogen chloride is introduced by means of a second gas supply apparatus located in the upper part of the reaction chamber or the reactor.

Preferably hydrogen chloride is introduced by means of a second gas supply apparatus located in the upper third of the reaction chamber.

It is also possible, however, to adjust the residence time of hydrogen chloride according to the invention in the reaction chamber by introducing hydrogen chloride at a high gas velocity by means of jets located in the wall or in a position within the upper part of the reactor.

Another possibility of adjusting the residence time is to add hydrogen chloride in position in the reactor where the velocity is very high. This is the case, for example, in a solid separating cyclone or solid separator located behind or above the reactor or in an area where material is recycled that is separated in the cyclone or the solid separator. The residence time of hydrogen chloride can be adjusted, for example, in a position where the material that is carried out of the fluidized bed is separated from the gas stream (cyclone or solid separator).

The method according to the invention is carried out, for example, at pressures of 1 to 150 bar, preferably 10 to 60 bar, particularly preferred 25 to 40 bar.

The process is carried out, for example, at temperatures from 350 to 800° C., preferably from 400 to 700° C., particularly preferred from 500 to 650° C.

The selection of the reactor for the reaction according to the invention is not critical, provided that under the reaction conditions the reactor shows adequate stability and permits the contact of the starting materials. The process can be carried out, for example, in a fixed bed reactor, a rotary tubular kiln or a fluidized-bed reactor. It is preferred to carry out the reaction in a fluidized-bed reactor.

Particularly preferred the reaction of silicon with silicon tetrachloride, hydrogen and hydrogen chloride is carried out in a reactor wherein the introduced gas streams in a way through the silicon particles introduced such that the particles are fluidized and a fluidized bed develops. The stream-in velocity of the introduced gas must correspond to at least the loosening velocity. Loosening velocity in this case is to be understood as the velocity at which a gas streams through a bed of particles and below which the fixed bed is maintained, i.e. below which the bed particles remain largely fixed. Above this velocity the bed starts fluidizing, i.e. the bed particles move and bubbles begin to emerge.

The stream-in velocity of the introduced gas in this preferred embodiment is one to ten times the loosening velocity, preferably one and a half to five times the loosening velocity.

On principle, it is possible to add a catalyst when executing the method according to the invention. Suitable catalysts are, for example, Copper, copper oxide, mixed copper oxide, iron, ferrous chloride, iron oxides, nickel, nickel chloride, nickel oxide. When executing the method according to the invention, however, it is not necessary to add any catalyst.

When adding catalyst, the amount of catalyst used is, for example, 0.1 to 20 weight percent, preferably 0.3 to 7.5 weight percent, based on the silicon employed.

In the method according to the invention any type of silicon can be used. It is preferred, however, to use metallurgical silicon or ferrosilicon. Metallurgical silicon in this meaning refers to silicon containing up to approx. 3 weight percent iron, 0.75 weight percent aluminium, 0.5 weight percent calcium and other impurities as can usually be found in silicon obtained by carbothermal reduction of silicon.

It is particularly preferred to use silicon with a total contents of additional components and contamination of up to 20 weight percent.

Particularly preferably silicon in the form of largely spherical silicon particles is employed.

The requirements as to the purity of the educts hydrogen chloride, silicon tetrachloride and hydrogen depend on the purity the produced trichlorosilane is supposed to have.

Preferably high-purity trichlorosilane is produced in accordance with the inventive method. In such case the educts provide also a highest possible purity.

Hydrogen and silicon tetrachloride can be employed, for example, in a mol ratio of 0.6:1 to 5:1, preferably 0.6:1 to 4:1, particularly preferred 0.6:1 to 3:1.

The trichlorosilane produced according to the method according to the invention can be used, for example, for the manufacture of silane and/or hyper-pure silicon.

Preferably the method according to the invention is integrated into a general method for producing hyper-pure silicon.

The method according to the invention is being explained in more detail by means of the following examples, without restricting the inventive idea insofar.

### EXAMPLES

### Example 1

(Reaction of Silicon with Hydrogen Chloride without Addition of H₂/SiCl₄)

400 g metallurgical silicon (99.3 weight percent silicon, average diameter of particles Dp=250-315 μm) were provided in a fluidized-bed reactor with an internal diameter I.D.=0.05 m. The silicon was reacted with hydrogen chloride at a temperature T=510° C. or 603° C. and a total pressure of Pₜₒₜ=1.1 bar. The educt gas composition was 96 volume percent N₂ to 4 volume percent hydrogen chloride. The educt gas mixture was added a) by means of a gas distributor located in the reactor bottom and b) by means of a second gas distributor located 1 cm below the expanded height of the fluidized bed. When adding the educt gas mixture by means of a gas distributor located in the reactor bottom (case a) the selectivity to trichlorosilane is 9% when carrying out the reaction at T=603° C. and 31% when carrying out the reaction at T=5 10° C. Introducing the educt gas mixture in the upper region of the reactor (case b) results in an increase of the selectivity to trichlorosilane to 51% when the reaction is carried out at T=603° C. and to 82% when the reaction is carried out at T=510° C., which corresponds to an increase of 42-51%. The amount of material reacting decreased slightly only from 88 to 84% (T=603° C.) and from 80 to 70% (T=510° C.).

Example 1 shows that the selectivity for trichlorosilane when reacting silicon with hydrogen chloride increases clearly with decreasing residence time of hydrogen chloride in the reaction chamber.

### Example 2

400 g metallurgical silicon (99.3 weight percent silicon, average diameter of particles Dp=250-315 μm) were provided in a fluidized-bed reactor with an internal diameter I.D.=0.05 m and were reacted with silicon tetrachloride, hydrogen and hydrogen chloride at a temperature T=510° C. and a total pressure of pₜₒₜ=1.1 bar. The mol ratio H₂/SiCl₄ was 2 in the presence of 20 volume percent N₂ and under addition of 4 volume percent hydrogen chloride. The H₂/SiCl₄ mixture was added by means of a gas distributor located in the reactor bottom. The educt gas mixture was added a) also by means of the gas distributor located in the reactor bottom and b) by means of a second gas distributor located 1 cm below the expanded height of the fluidized bed. In case a) a total yield of 9.4% (based on the amount of Cl introduced in the reactor) was obtained with a hydrogen chloride conversion of 95%. In case b) the addition of hydrogen chloride in the upper region of the reaction chamber results in an increase of the total yield of trichlorosilane to 11.4% (based on the amount of Cl introduced in the reactor), while the conversion of hydrogen chloride decreased slightly only to 80%.

The total yield of trichlorosilane is defined by the formula

$${Y}_{{SiHCl}_{3}} = \frac{3}{4} \cdot \frac{{p}_{{SiHCl}_{3}}}{( {p}_{{SiCl}_{4}} + \frac{3}{4} {p}_{{SiHCl}_{3}} + \frac{2}{4} {p}_{{SiH}_{2} {Cl}_{2}} + \frac{1}{4} {p}_{HCl} )}$$

wherein p is the partial pressure and all partial pressures are based on the product gas.

1. A method for producing trichlorosilane by reacting silicon with silicon tetrachloride and hydrogen while adding hydrogen chloride, characterised in that the residence time of the hydrogen chloride in the reaction chamber is 10⁻³ to 50% of the residence time of the silicon tetrachloride.

2. A method according to claim 1, characterised in that the residence time of the hydrogen chloride in the reaction chamber is 10⁻³ to 20% of the residence time of silicon tetrachloride.

3. A method according to at least one of claims 1 to 2, characterised in that the reaction is carried out at a temperature from 350 to 800° C.

4. A method according to at least one of claims 1 to 3, characterised in that the reaction is carried out at pressures from 1 to 150 bar.

5. A method according to at least one of claims 1 to 4, characterised in that the reaction is carried out in a reactor wherein the introduced gas streams in a way through the silicon particles introduced such that the particles are fluidized and a fluidized bed develops.

6. A method according to at least one of claims 1 to 5, characterised in that the residence time of hydrogen chloride is adjusted in that silicon tetrachloride and hydrogen are introduced from below in the reaction chamber by means of a gas distributor, while hydrogen chloride is introduced by means of a second gas supply apparatus located in the upper part of the reaction chamber or the reactor.

7. A method according to at least one of claims 1 to 5, characterised in that silicon is carried out from the reactor and that the residence time of hydrogen chloride is adjusted by adding such hydrogen chloride in a position where the material that was carried out of the fluidized bed is separated from the gas stream.

8. A method according to at least one of claims 1 to 5, characterised in that silicon is carried out from the reactor and is returned back into the reactor again and that the residence time of hydrogen chloride is adjusted by adding such hydrogen chloride in such area where the solids that were carried out from the reactor are returned into the reactor again.

9. A method according to at least one of claims 1 to 8, characterised in that 0.05-20 weight percent hydrogen chloride based on the amount of silicon tetrachloride added is employed.

10. A method for producing silane and/or hyper-pure silicon, characterised in that the starting material is trichlorosilane obtained according to claims 1 to 9.
